(19) United States
(12) Patent Application Publication
(10) Pub. No.: US 2024/0011923 A1
(43) Pub. Date: Jan. 11, 2024

(54) SYSTEMS AND METHODS FOR ANALYTE SENSING OF MULTIPLE ANALYTES

(71) Applicant: Know Labs, Inc., Seattle, WA (US)

(72) Inventor: Phillip BOSUA, Seattle, WA (US)

(21) Appl. No.: 17/859,787

(22) Filed: Jul. 7, 2022

(51) Int. Cl. G01N 22/00

(52) U.S. Cl. CPC G01N 22/00

(57) ABSTRACT

A method of operating a sensor system with a non-invasive sensor having a plurality of antenna to detect analytes in a target includes determining a first detection frequency sweep and determining a second detection frequency sweep. The method also includes transmitting first transmit signals at transmit frequencies of the first detection frequency sweep and detecting resulting first response signals. The method further includes transmitting second transmit signals at transmit frequencies of the second detection frequency sweep and detecting resulting second response signals. A sensor system includes a non-invasive sensor and a controller. First detection parameters for detecting a first analyte and second detection parameters for detecting the second analyte are stored on a memory of the sensor system. A non-invasive sensor includes a plurality of antennas and a controller with a memory.

### FIELD

This disclosure is directed to analyte sensors and analyte detection methods for sensing multiple analytes in a target.

### BACKGROUND

There is interest in being able to detect and/or measure analytes within a target. One example is measuring glucose in biological tissue. Another example, is measuring alcohol in a blood sample. Many non-invasive sensors are configured to sense one specific analyte within a target. However, many previous sensors, and in particular many non-invasive sensors, are unable to sense multiple analytes and/or suffer from inaccurate measurements when used to sense multiple analytes within a target.

### SUMMARY

This disclosure is directed to analyte sensors and analyte detection methods for sensing multiple analytes in a target.

In an embodiment, a method is directed to operating a sensor system to detect a first analyte and a second analyte in a target. The first analyte is a different analyte from the second analyte. The sensor system includes a non-invasive sensor having a plurality of antennas. The method includes determining a first detection frequency sweep based on the first analyte to be detected and determining a second detection frequency sweep based on the second analyte to be detected. The first detection frequency sweep includes first detection parameters and the second detection frequency sweep includes second detection parameters. At least one of the first detection parameters in the first detection frequency sweep is different from a corresponding one of the second detection parameters in the second detection frequency sweep. The method further includes transmitting, using at least a first transmit antenna of the plurality of antennas, first transmit signals at a first plurality of transmit frequencies of the first detection frequency sweep, and detecting, using at least a first receive antenna of the plurality of antennas, first response signals. The first transmit signals being in a radio or microwave range of the electromagnetic spectrum. The first response signals result from the transmission of the first transmit signals by at least the first transmit antenna into the target. The method further includes transmitting, using at least a second transmit antenna of the plurality of antennas, second transmit signals at a second plurality of transmit frequencies of the second detection frequency sweep, and detecting, using at least a second receive antenna of the plurality of antennas, second response signals. The second transmit signals are in a radio or microwave range of the electromagnetic spectrum. The second response signals result from the transmission of the second transmit signals by at least the second transmit antenna into the target.

In an embodiment, a sensor system includes a non-invasive sensor for detecting a first analyte and a second analyte in a target and a controller with a non-transitory memory. The first analyte is a different analyte from the second analyte. The non-invasive sensor includes a plurality of antennas positioned and arranged to transmit into the target and to detect a response resulting from the transmitting into the target. First detection parameters for detecting the first analyte and second detection parameters for detecting the second analyte are stored in the non-transitory memory. The controller is configured to control the non-invasive sensor to detect the first analyte and the second analyte in the target. The controller determines a first frequency sweep having the first detection parameters stored in the non-transitory memory for detecting the first analyte, and determines a second frequency sweep having the second detection parameters stored in the non-transitory memory for detecting the second analyte. At least one of the first detection parameters in the first detection frequency sweep is different from a corresponding one of the second detection parameters in the second detection frequency sweep. The controller also transmits, using at least a first transmit antenna of the plurality of antenna, first transmit signals at a first plurality of transmit frequencies of the first detection frequency sweep, and detects, using at least a first receive antenna of the plurality of antennas, first response signals. The first transmit signals are in a radio or microwave range of the electromagnetic spectrum. The first response signals result from the transmission of the first transmit signals by at least the first transmit antenna into the target. The controller also transmits, using at least a second transmit antenna of the plurality of antennas, second transmit signals at a second plurality of transmit frequencies of the second detection frequency sweep, and detects, using at least a second receive antenna of the plurality of antennas, second response signals. The second transmit signals are in a radio or microwave range of the electromagnetic spectrum. The second response signals result from the transmission of the second transmit signals by at least the second transmit antenna into the target.

In an embodiment, a non-invasive sensor is configured to detect a first analyte and a second analyte in a target. The non-invasive sensor includes a plurality of antennas and a controller. The plurality of antennas positioned and arranged to transmit into the target and to detect a response resulting from the transmitting into the target. The controller includes a non-transitory memory. First detection parameters for detecting the first analyte and second detection parameters for detecting the second analyte are stored in the non-transitory memory. The controller is configured to control the non-invasive sensor to detect the first analyte and the second analyte in the target. The controller determines a first frequency sweep having the first detection parameters stored in the non-transitory memory for detecting the first analyte, and determines a second frequency sweep having the second detection parameters stored in the non-transitory memory for detecting the second analyte. At least one of the first detection parameters in the first detection frequency sweep is different from a corresponding one of the second detection parameters in the second detection frequency sweep. The controller also transmits, using at least a first transmit antenna of the plurality of antenna, first transmit signals at a first plurality of transmit frequencies of the first detection frequency sweep, and detects, using at least a first receive antenna of the plurality of antennas, first response signals. The first transmit signals are in a radio or microwave range of the electromagnetic spectrum. The first response signals result from the transmission of the first transmit signals by at least the first transmit antenna into the target. The controller also transmits, using at least a second transmit antenna of the plurality of antennas, second transmit signals at a second plurality of transmit frequencies of the second detection frequency sweep, and detects, using at least a second receive antenna of the plurality of antennas, second response signals. The second transmit signals are in a radio or microwave range of the electromagnetic spectrum. The second response signals result from the transmission of the second transmit signals by at least the second transmit antenna into the target.

### DRAWINGS

FIG. 1 shows an embodiment of an analyte detection system.

FIG. 2 shows an embodiment of an antenna array of a sensor in an analyte detection system.

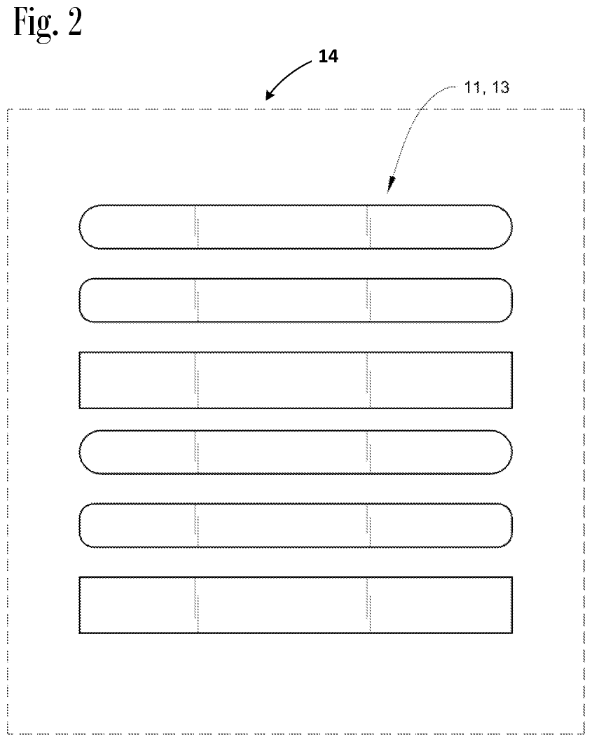

FIG. 3 shows a block flow diagram of a method of detecting a first analyte and a second analyte.

Like numbers represent like features.

### DETAILED DESCRIPTION

This disclosure is directed to sensing for detection of multiple analytes in a target.

Transmit antenna(s) and receive antenna(s) can be located near the target and operated as further described herein to assist in detecting a plurality of analytes in the target. The transmit antenna(s) transmit signals in the radio or microwave frequency range toward and into the target. The receive antenna detect a response (e.g., response signals) resulting from the transmission of the signal(s) by the transmit antenna(s) into the target containing the analytes of interest.

The transmit antenna(s) used for transmitting signals and the receive antenna(s) used for receiving the resulting response are decoupled (which may also be referred to as detuned or the like) from one another. Decoupling refers to intentionally fabricating the configuration and/or arrangement of the transmit antenna(s) and the receive antenna(s) to minimize direct communication between the transmit antenna(s) and the receive antenna(s), preferably absent shielding. Shielding between the transmit antenna(s) and the receive antenna(s) can be utilized. However, the transmit antenna(s) and the receive antenna(s) are decoupled even without the presence of shielding.

The signal(s) detected by the receive antenna(s) can be analyzed to detect the analyte based on the intensity of the received signal(s) and reductions in intensity at one or more frequencies where the analyte absorbs the transmitted signal. Examples of detecting an analyte using a non-invasive spectroscopy sensor operating in the radio or microwave frequency range of the electromagnetic spectrum are described in WO 2019/217461, U.S. Pat. Nos. 11,063,373, 11,058,331, 11,033,208, 11,284,819, 11,284,820, 10,548,503, 11,234,619, 11,031,970, 11,223,383, 11,058,317, 11,193,923, and 11,234,618, the entire contents of which are incorporated herein by reference.

In one embodiment, the sensor described herein can be used to detect the presence of two or more analytes in a target (i.e., presence of a first analyte and a second analyte). In another embodiment, the sensor described herein can detect an amount or a concentration of each of the analytes in the target. The target can be any target containing at least one analyte of interest that one may wish to detect. The target can be human or non-human, animal or non-animal, biological or non-biological. For example, the target can include, but is not limited to, human tissue, animal tissue, plant tissue, an inanimate object, soil, a fluid, genetic material, or a microbe. Non-limiting examples of targets include, but are not limited to, a fluid, for example blood, interstitial fluid, cerebral spinal fluid, lymph fluid or urine, human tissue, animal tissue, plant tissue, an inanimate object, soil, genetic material, or a microbe.

The analyte(s) can be any analyte that one may wish to detect. The analyte can be human or non-human, animal or non-animal, biological or non-biological. For example, the analyte(s) can include, but is not limited to, one or more of glucose, alcohol, white blood cells, or luteinizing hormone. The analyte(s) can include, but is not limited to, a chemical, a combination of chemicals, a virus, bacteria, or the like. The analyte can be a chemical included in another medium, with non-limiting examples of such media including a fluid containing the at least one analyte, for example blood, interstitial fluid, cerebral spinal fluid, lymph fluid or urine, human tissue, animal tissue, plant tissue, an inanimate object, soil, genetic material, or a microbe. The analyte(s) may also be a non-human, non-biological particle such as a mineral or a contaminant.

The analyte(s) can include, for example, naturally occurring substances, artificial substances, metabolites, and/or reaction products. As non-limiting examples, the at least one analyte can include, but is not limited to, insulin, acarboxyprothrombin; acylcarnitine; adenine phosphoribosyl transferase; adenosine deaminase; albumin; alpha-fetoprotein; amino acid profiles (arginine (Krebs cycle), histidine/urocanic acid, homocysteine, phenylalanine/tyrosine, tryptophan); andrenostenedione; antipyrine; arabinitol enantiomers; arginase; benzoylecgonine (cocaine); biotinidase; biopterin; c-reactive protein; carnitine; pro-BNP; BNP; troponin; carnosinase; CD4; ceruloplasmin; chenodeoxycholic acid; chloroquine; cholesterol; cholinesterase; conjugated 1-β hydroxy-cholic acid; cortisol; creatine kinase; creatine kinase MM isoenzyme; cyclosporin A; d-penicillamine; de-ethylchloroquine; dehydroepiandrosterone sulfate; DNA (acetylator polymorphism, alcohol dehydrogenase, alpha 1-antitrypsin, cystic fibrosis, Duchenne/Becker muscular dystrophy, analyte-6-phosphate dehydrogenase, hemoglobin A, hemoglobin S, hemoglobin C, hemoglobin D, hemoglobin E, hemoglobin F, D-Punjab, beta-thalassemia, hepatitis B virus, HCMV, HIV-1, HTLV-1, Leber hereditary optic neuropathy, MCAD, RNA, PKU, Plasmodium vivax, sexual differentiation, 21-deoxycortisol); desbutylhalofantrine; dihydropteridine reductase; diptheria/tetanus antitoxin; erythrocyte arginase; erythrocyte protoporphyrin; esterase D; fatty acids/acylglycines; free β-human chorionic gonadotropin; free erythrocyte porphyrin; free thyroxine (FT4); free tri-iodothyronine (FT3); fumarylacetoacetase; galactose/gal-1-phosphate; galactose-1-phosphate uridyltransferase; gentamicin; analyte-6-phosphate dehydrogenase; glutathione; glutathione perioxidase; glycocholic acid; glycosylated hemoglobin; halofantrine; hemoglobin variants; hexosaminidase A; human erythrocyte carbonic anhydrase I; 17-alpha-hydroxyprogesterone; hypoxanthine phosphoribosyl transferase; immunoreactive trypsin; lactate; lead; lipoproteins ((a), B/A-1, β); lysozyme; mefloquine; netilmicin; phenobarbitone; phenytoin; phytanic/pristanic acid; progesterone; prolactin; prolidase; purine nucleoside phosphorylase; quinine; reverse tri-iodothyronine (rT3); selenium; serum pancreatic lipase; sissomicin; somatomedin C; specific antibodies (adenovirus, anti-nuclear antibody, anti-zeta antibody, arbovirus, Aujeszky's disease virus, dengue virus, Dracunculus medinensis, Echinococcus granulosus, Entamoeba histolytica, enterovirus, Giardia duodenalisa, Helicobacter pylori, hepatitis B virus, herpes virus, HIV-1, IgE (atopic disease), influenza virus, Leishmania donovani, leptospira, measles/mumps/rubella, Mycobacterium leprae, Mycoplasma pneumoniae, Myoglobin, Onchocerca volvulus, parainfluenza virus, Plasmodium falciparum, polio virus, Pseudomonas aeruginosa, respiratory syncytial virus, rickettsia (scrub typhus), Schistosoma mansoni, Toxoplasma gondii, Trepenoma pallidium, Trypanosoma cruzi/rangeli, vesicular stomatis virus, Wuchereria bancrofti, yellow fever virus); specific antigens (hepatitis B virus, HIV-1); succinylacetone; sulfadoxine; theophylline; thyrotropin (TSH); thyroxine (T4); thyroxine-binding globulin; trace elements; transferrin; UDP-galactose-4-epimerase; urea; uroporphyrinogen I synthase; vitamin A; white blood cells; and zinc protoporphyrin.

The analyte(s) can also include one or more chemicals introduced into the target. The analyte(s) can include a marker such as a contrast agent, a radioisotope, or other chemical agent. The analyte(s) can include a fluorocarbon-based synthetic blood. The analyte(s) can include a drug or pharmaceutical composition, with non-limiting examples including ethanol or other alcohols; ketones; cannabis (marijuana, tetrahydrocannabinol, hashish); inhalants (nitrous oxide, amyl nitrite, butyl nitrite, chlorohydrocarbons, hydrocarbons); cocaine (crack cocaine); stimulants (amphetamines, methamphetamines, Ritalin, Cylert, Preludin, Didrex, PreState, Voranil, Sandrex, Plegine); depressants (barbiturates, methaqualone, tranquilizers such as Valium, Librium, Miltown, Serax, Equanil, Tranxene); hallucinogens (phencyclidine, lysergic acid, mescaline, peyote, psilocybin); narcotics (heroin, codeine, morphine, opium, meperidine, Percocet, Percodan, Tussionex, Fentanyl, Darvon, Talwin, Lomotil); designer drugs (analogs of fentanyl, meperidine, amphetamines, methamphetamines, and phencyclidine, for example, Ecstasy); anabolic steroids; and nicotine. The analyte(s) can include other drugs or pharmaceutical compositions. The analyte(s) can include neurochemicals or other chemicals generated within the body, such as, for example, ascorbic acid, uric acid, dopamine, noradrenaline, 3-methoxytyramine (3MT), 3,4-Dihydroxyphenylacetic acid (DOPAC), Homovanillic acid (HVA), 5-Hydroxytryptamine (5HT), and 5-Hydroxyindoleacetic acid (FHIAA).

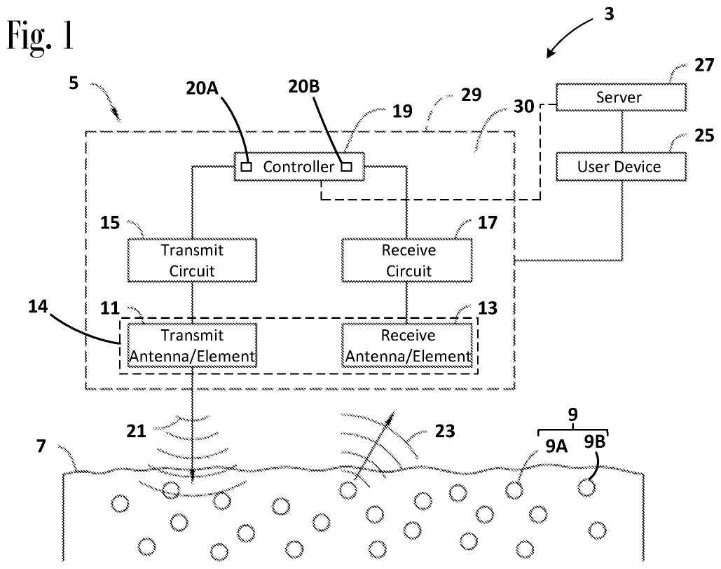

FIG. 1 shows an embodiment of an analyte sensor system 3 with a non-invasive analyte sensor 5. The non-invasive analyte sensor 5 is depicted relative to a target 7 that contains one or more non-invasively detected analytes of interest 9. In this example, the non-invasive analyte sensor 5 is depicted as including an antenna array 14 that includes a transmit antenna/element 11 (hereinafter “transmit antenna 11”) and a receive antenna/element 13 (hereinafter “receive antenna 13”). The sensor 5 further includes a transmit circuit 15, a receive circuit 17, and a controller 19. The non-invasive analyte sensor 5 is configured to detect the one or more non-invasively detected analytes of interest 9 in the target 7 without physical disruption to the target, as described below using transmission of electromagnetic signals and detection of responses for detection of the one or more non-invasively detected analytes of interest 9. Target 7 can be a living subject, for example a person in which the one or more analytes of interest 9 are to be detected. Target 7 can be a portion of a living subject, such as skin, blood, interstitial fluid, or the like. When the target 7 is a living subject, the receive antenna 13 may simultaneously detect the analyte present in at least both the blood and the interstitial fluid of the living subject.

The transmit antenna 11 is positioned, arranged and configured to transmit a signal 21 that is in the radio frequency (RF) or microwave range of the electromagnetic spectrum into the target 7. The transmit antenna 11 can be an electrode or any other suitable transmitter of electromagnetic signals in the radio frequency (RF) or microwave range. The transmit antenna 11 can have any arrangement and orientation relative to the target 7 that is sufficient to allow the analyte sensing to take place. In one non-limiting embodiment, the transmit antenna 11 can be arranged to face in a direction that is substantially toward the target 7.

The signal 21 transmitted by the transmit antenna 11 is generated by the transmit circuit 15 which is electrically connectable to the transmit antenna 11. The transmit circuit 15 can have any configuration that is suitable to generate a transmit signal to be transmitted by the transmit antenna 11. Transmit circuits for generating transmit signals in the RF or microwave frequency range are well known in the art. In one embodiment, the transmit circuit 15 can include, for example, a connection to a power source, a frequency generator, and optionally filters, amplifiers or any other suitable elements for a circuit generating an RF or microwave frequency electromagnetic signal. In an embodiment, the signal generated by the transmit circuit 15 can have a frequency that is in the range from about 10 kHz to about 100 GHz. In another embodiment, the frequency can be in a range from about 300 MHz to about 6000 MHz. In an embodiment, the transmit circuit 15 can be configured to sweep through a range of frequencies that are within the range of about 10 kHz to about 100 GHz, or in another embodiment a range of about 300 MHz to about 6000 MHz.

The receive antenna 13 is positioned, arranged, and configured to detect one or more electromagnetic response signals 23 that result from the transmission of the transmit signal 21 by the transmit antenna 11 into the target 7 and impinging on the one or more non-invasively detected analyte(s) 9. The receive antenna 13 can be an electrode or any other suitable receiver of electromagnetic signals in the radio frequency (RF) or microwave range. In an embodiment, the receive antenna 13 is configured to detect an electromagnetic signal having a frequency that is in the range from about 10 kHz to about 100 GHz, or in another embodiment a range from about 300 MHz to about 6000 MHz. The receive antenna 13 can have any arrangement and orientation relative to the target 7 that is sufficient to allow detection of the response signal(s) 23 to allow the analyte sensing to take place. In one non-limiting embodiment, the receive antenna 13 can be arranged to face in a direction that is substantially toward the target 7.

The receive circuit 17 is electrically connectable to the receive antenna 13 and conveys the received response from the receive antenna 13 to the controller 19. The receive circuit 17 can have any configuration that is suitable for interfacing with the receive antenna 13 to convert the electromagnetic energy detected by the receive antenna 13 into one or more signals reflective of the response signal(s) 23. The construction of receive circuits are well known in the art. The receive circuit 17 can be configured to condition the signal(s) prior to providing the signal(s) to the controller 19, for example through amplifying the signal(s), filtering the signal(s), or the like. Accordingly, the receive circuit 17 may include filters, amplifiers, or any other suitable components for conditioning the signal(s) provided to the controller 19.

The controller 19 controls the operation of the sensor 5. The controller 19, for example, can direct the transmit circuit 15 to generate a transmit signal to be transmitted by the transmit antenna 11. The controller 19 further receives signals from the receive circuit 17. The controller 19 can optionally process the signals from the receive circuit 17 to detect the analyte(s) 9 in the target 7. In one embodiment, the controller 19 may optionally be in communication with at least one external device 25 such as a user device and/or a remote server 27, for example through one or more wireless connections such as Bluetooth, wireless data connections such a 4G, 5G, LTE or the like, or Wi-Fi. If provided, the external device 25 and/or remote server 27 may process (or further process) the signals that the controller 19 receives from the receive circuit 17, for example to detect the one or more non-invasively detected analyte(s) 9. If provided, the external device 25 may be used to provide communication between the sensor 5 and the remote server 27, for example using a wired data connection or via a wireless data connection or Wi-Fi of the external device 25 to provide the connection to the remote server 27.

With continued reference to FIG. 1, the sensor 5 may include a sensor housing 29 (shown in dashed lines) that defines an interior space 30. Components of the sensor 5 may be attached to and/or disposed within the housing 29. For example, the transmit antenna 11 and the receive antenna 13 are attached to the housing 29. In some embodiments, the antennas 11, 13 may be entirely or partially within the interior space 30 of the housing 29. In some embodiments, the antennas 11, 13 may be attached to the housing 29 but at least partially or fully located outside the interior space 30. In some embodiments, the transmit circuit 15, the receive circuit 17 and the controller 19 are attached to the housing 29 and disposed entirely within the sensor housing 29.

The receive antenna 13 can be decoupled or detuned with respect to the transmit antenna 11 such that electromagnetic coupling between the transmit antenna 11 and the receive antenna 13 is reduced. The decoupling of the transmit antenna 11 and the receive antenna 13 increases the portion of the signal(s) detected by the receive antenna 13 that is the response signal(s) 23 from the target 7, and minimizes direct receipt of the transmitted signal 21 by the receive antenna 13. The decoupling of the transmit antenna 11 and the receive antenna 13 results in transmission from the transmit antenna 11 to the receive antenna 13 having a reduced forward gain and an increased reflection at output compared to antenna systems having coupled transmit and receive antennas. In an embodiment, the transmit antenna 11 and/or the receive antenna 13 can be shape-changing antennas such as arrays of controllable circuits, controllable conductive materials, or the like. When used as transmit antenna 11 and/or receive antenna 13, the shape-changing antennas can be formed at specific times so as to reduce or eliminate direct receipt of transmitted signal 21 at receive antenna 13. When used as transmit antenna and/or receive antenna 13 can have shapes and/or positions selected such that transmit antenna 11 and receive antenna 13 are decoupled from one another.

In an embodiment, coupling between the transmit antenna 11 and the receive antenna 13 is 95% or less. In another embodiment, coupling between the transmit antenna 11 and the receive antenna 13 is 90% or less. In another embodiment, coupling between the transmit antenna 11 and the receive antenna 13 is 85% or less. In another embodiment, coupling between the transmit antenna 11 and the receive antenna 13 is 75% or less.

Any technique for reducing coupling between the transmit antenna 11 and the receive antenna 13 can be used. For example, the decoupling between the transmit antenna 11 and the receive antenna 13 can be achieved by one or more intentionally fabricated configurations and/or arrangements between the transmit antenna 11 and the receive antenna 13 that is sufficient to decouple the transmit antenna 11 and the receive antenna 13 from one another.

For example, the decoupling of the transmit antenna 11 and the receive antenna 13 can be achieved by intentionally configuring the transmit antenna 11 and the receive antenna 13 to have different geometries from one another. Intentionally different geometries refers to different geometric configurations of the transmit and receive antennas 11, 13 that are intentional. Intentional differences in geometry are distinct from differences in geometry of transmit and receive antennas that may occur by accident or unintentionally, for example due to manufacturing errors or tolerances.

Another technique to achieve decoupling of the transmit antenna 11 and the receive antenna 13 is to provide appropriate spacing between each antenna 11, 13 that is sufficient to decouple the antennas 11, 13 and force a proportion of the electromagnetic lines of force of the transmitted signal 21 into the target 7 thereby minimizing or eliminating as much as possible direct receipt of electromagnetic energy by the receive antenna 13 directly from the transmit antenna 11 without traveling into the target 7. The appropriate spacing between each antenna 11, 13 can be determined based upon factors that include, but are not limited to, the output power of the signal from the transmit antenna 11, the size of the antennas 11, 13, the frequency or frequencies of the transmitted signal, and the presence of any shielding between the antennas. This technique helps to ensure that the response detected by the receive antenna 13 is measuring the analyte 9 and is not just the transmitted signal 21 flowing directly from the transmit antenna 11 to the receive antenna 13. In some embodiments, the appropriate spacing between the antennas 11, 13 can be used together with the intentional difference in geometries of the antennas 11, 13 to achieve decoupling.

In one embodiment, the transmit signal (or each of the transmit signals) can be transmitted over a transmit time that is less than, equal to, or greater than about 300 ms. In another embodiment, the transmit time can be than, equal to, or greater than about 200 ms. In still another embodiment, the transmit time can be less than, equal to, or greater than about 30 ms. The transmit time could also have a magnitude that is measured in seconds, for example 1 second, 5 seconds, 10 seconds, or more. In an embodiment, the same transmit signal can be transmitted multiple times, and then the transmit time can be averaged. In another embodiment, the transmit signal (or each of the transmit signals) can be transmitted with a duty cycle that is less than or equal to about 50%. In an embodiment, the transmit signals can form frequency sweeps having frequency steps with selected operations times to facilitate comparison of frequency sweep results, as discussed in U.S. Pat. No. 11,033,208, which is herein incorporated by reference in its entirety.

The transmit signals may transmit in the form of frequency sweeps for detecting analytes 9 in a target 7. A range of frequencies can be swept by sequentially transmitting a transmit signal at consecutive steps through said range. For example, a first transmit signal is transmitted at the minimum frequency in the range (which can be referred to as the first frequency step), a second transmit signal is transmitted at a frequency that is step greater than the first step (which can be referred to as the second frequency step), a third transmit signal is transmitted at a frequency that is step greater than the second frequency step (which can be referred to as the second frequency step), etc. This continues until a transmit signal is transmitted at the maximum frequency in the range. Alternatively, a frequency sweep may start at the maximum frequency and go down by frequency steps instead. A first frequency sweep (which can be referred to as a detection frequency sweep) can be employed to detecting for a first analyte 9A in the target 7, as described herein. A second frequency sweep different from the first frequency sweep (which can be referred to as a detection frequency sweep) can employed to detect for a second analyte 9B in the target 7, as described herein.

The system 3 includes a memory 20A (i.e., a non-transitory memory) and a processor 20B that can control the sensor 3 to detect the analytes 9 in the target 7. The controller 19 of the sensor 5 can include the memory 20A and the processor 20B. Detection parameters for frequency sweeps for detecting different analytes may be stored in the memory 20A. Transmit signals 21 are transmitted at a plurality of transmit frequencies to perform a frequency sweep. The plurality of transmit frequencies are at the frequency steps of the frequency sweep. For example, a frequency sweep is performed by transmitting a respective transmit signal 21 at each frequency step in the frequency range of the frequency sweep.

First detection parameters and second detection parameters can be stored in the memory 20A. The first detection parameters are parameters of a detection frequency sweep for detecting the first analyte 9A. The second detection parameters are parameters of a detecting frequency sweep for detecting the second analyte 9B. The sensor 5 (e.g., the controller 19 of the sensor 5) may determine a first detection frequency sweep for detecting the first analyte 9A by selecting the (first) detection parameters stored in the memory 20A for the first frequency sweep. The sensor 5 (e.g., the controller 19 of the sensor 5) may determine a second detection frequency sweep for detecting the second analyte 9B by selecting the (second) detection parameters stored in the memory 20A for detecting the second analyte 9B.

Each analyte 9A, 9B that is detected may be present in blood, in interstitial fluid, or in both the blood and the interstitial fluid of the target 7 (e.g., of a person or other target). The first analyte 9A may be present in blood, in interstitial fluid, or in both interstitial fluid and blood of the target 7. The second analyte 9B may be present in blood, in interstitial fluid, or in both interstitial fluid and blood of the target 7. In an embodiment, the sensor 5, when used on a target 9 that includes both blood and interstitial fluid, detects one or both of the analytes 9A, 9B from both blood and the interstitial fluid (e.g., the first analyte 9A may be detected from both blood and interstitial fluid, or from only blood or from only interstitial fluid; the second analyte 9B may be detected from either blood or interstitial fluid, or from both blood and interstitial fluid).

Transmit signals 21 are transmitted at a plurality of transmit frequencies of the detection frequency sweep to perform the detection frequency sweep. The detection parameters for a detection frequency sweep are for the transmit signals of the detection frequency sweep. For example, detection parameters for a detection frequency sweep can include a frequency range, a power level, and/or a frequency step size. For example, the frequency range is the range of frequencies swept by the sweep (e.g., frequency range defined by the highest frequency transmit signal to the lowest frequency transmit signal in the frequency sweep). For example, the power level includes amplitude(s) for the transmit signals of the sweep (e.g., amplitude for each of the transmit signals, plurality of amplitudes for the transmit signals). Within a frequency sweep, all of the transmit signals may be transmitted with the same power level, or the transmit signals within the frequency sweep may be transmitted at different power levels (i.e., one or more of the transmit signals within the frequency sweep being transmitted at a first power level and one or more other transmit signals within the same frequency sweep being transmitted at a second power level). The frequency step size is the frequency difference(s) between transmit signals in the sweep (e.g., a frequency difference between one transmit signal and the next transmit signal in the frequency sweep). The frequency step size may have a constant size within the frequency sweep or may vary within the frequency sweep (e.g., the frequency difference between steps decreases or increases closer to a specific frequency within the sweep). The detection parameters for the frequency detection sweep can also include timing parameters for the detection frequency sweep (e.g., operation time of each the transmit signal, time delay between consecutive transmit signals in the sweep, etc.).

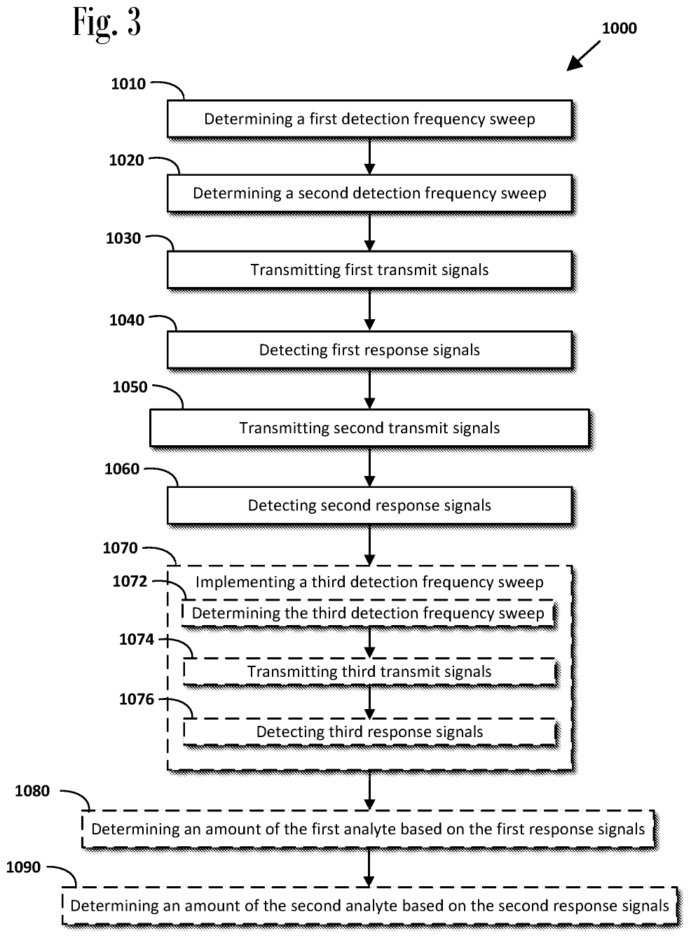

FIG. 3 shows an embodiment of a method 1000 of operating a sensor system described herein, such as the sensor system 3 in FIG. 1. For example, the method 1000 may be implemented by a non-invasive sensor (e.g., the controller 19 of the sensor 5) and/or a user device (e.g., a controller of the user device 25) of the sensor system 3. The non-invasive sensor includes a plurality of antennas (e.g., antennas 11, 13 in the antenna array 14). The method 1000 operates the sensor system to detect a first analyte (e.g., first analyte 9A) and a second analyte (e.g., second analyte 9B) in a target (e.g., target 7) using the non-invasive sensor.

The method 1000 and sensor system may be used for detecting the first analyte and the second analyte in a living target such as a person. In an embodiment, the sensor system is a non-invasive sensor system configured to non-invasively detect the first and second analytes in the target using the non-invasive sensor. For example, the target is a person, and the method 1000 non-invasively detects the first and second analytes in the person using the non-invasive sensor system. In another embodiment, the target may be a blood or tissue sample that is taken from a person, and the sensor system uses the non-invasive sensor to detect the analytes in the blood or tissue sample. In such an embodiment, the sensor system may be referred to an invasive sensor system as it detects the first and second analyte in a person by detecting the first and second analyte in the invasively taken tissue or blood sample. In such an embodiment, the method 1000 is directed to detecting the first and second analytes in the target as the method 1000 operates the sensor system to detect the first and second analytes in the invasively taken tissue or blood sample. However, even when the blood or tissue sample is removed from the body, the sensor may still be referred to as non-invasive since the sensor itself is operating non-invasively even if the target has been invasively removed.

The first analyte and the second analyte are different analytes. The first analyte and the second analyte can be selected from the analytes described herein. In an embodiment, the first analyte may be glucose. The second analyte may be a drug or pharmaceutical composition, or a chemical that is generated within the body as described herein. For example, the second analyte may be alcohol.

The method 1000 includes determining a first detection frequency sweep at 1010, determining a second detection sweep at 1020, transmitting first transmit signals at 1030, detecting first response signals at 1040, transmitting second transmit signals at 1050, and detecting second response signals at 1060. The method 1000 may also implementing include determining an amount of the first analyte based on the first response signals at 1080 and/or determining an amount of the second analyte based on the second response signals at 1090.

At 1010, a first detection frequency sweep is determined based on the first analyte to be detected. The first detection frequency sweep includes (first) detection parameters. The detection parameters of the first detection frequency sweep are configured for detecting the first analyte in the target. For example, the first detection parameters are based on one or more properties of the first analyte. In an embodiment, the determination of the first detection frequency sweep 1010 may include selecting (first) detection parameters stored in the memory of the sensor (e.g., memory 20A of sensor 5) for detecting the first analyte for the first detection frequency sweep. The first detection parameters are selected based on being useful for sensing the first analyte. For example, the detection parameters are selected for the transmit signals of the first detection frequency sweep to interact with first analyte and cause (first) response signals in a manner suitable for detection by the sensor (e.g., in manner that is generally and consistently repeatable and is useable for detecting/measuring the first analyte in the target). The first detection parameters of the first detection frequency sweep can include a (first) frequency range, a (first) power level, and/or a (first) frequency step size. The detection parameters may include the frequency range and the frequency step size in the form of the specific transmit frequencies for the first detection frequency sweep (e.g., the transmit frequencies defined by the first frequency range and the first frequency step size, the first plurality of transmit frequencies).

At 1020, the second detection frequency sweep is determined based on the second analyte to be detected. The second detection frequency sweep includes (second) detection parameters. The detection parameters of the second detection frequency sweep are configured for detecting the second analyte in the target. For example, the second detection parameters are based on one or more properties of the second analyte. In an embodiment, the determination of the second detection frequency sweep 1020 may include selecting (second) detection parameters stored in the memory of the sensor (e.g., memory 20A of sensor 5) for the second detection frequency sweep. The second detection parameters are selected based on being useful for sensing the second analyte. For example, the detection parameters are selected for the transmit signals of the second detection frequency sweep to interact with second analyte and cause the (second) response signals in a manner suitable for detection by the sensor (e.g., in manner that is generally and consistently repeatable and is useable for detecting/measuring the second analyte in the target). The detection parameters of the detection frequency sweep can include a (second) frequency range, a (second) power level, and a (second) frequency step size. The second detection parameters may include the frequency range and the frequency step size in the form of the specific transmit frequencies for the transmit signals for the second detection frequency sweep (e.g., the transmit frequencies defined by the frequency range and the frequency step size, the second plurality of transmit frequencies).

At 1030, the sensor transmits the first transmit signals at a first plurality of transmit frequencies of the first detection frequency sweep. The first transmit signals are in a radio or microwave range of the electromagnetic spectrum. The first transmit signals are transmitted using a first transmit antenna of the plurality of antennas of the sensor (e.g., transmit antenna 11). The transmitted first plurality of transmit frequencies have the (first) detection parameters so as to implement the first transmit frequency sweep. For example, the first plurality of transmit frequencies are at the (first) power level, in the (first) frequency range, and/or at the (first) frequency step size. For example, the first plurality of transmit frequencies can include a transmit signal having the upper frequency limit of the first frequency range, a transmit signal having the lower frequency limit of the first frequency range, and one or more transmit signals at each frequency step between the maximum frequency and the minimum frequency.

At 1040, the sensor detects (first) response signals at the first plurality of transmit frequencies. The first response signals are detected using at least a first receive antenna of the plurality of the antennas of the sensor (e.g., one or more receive antennas 13 of the antenna array 14). The (first) response signals result from the transmission of the (first) transmit signals by the first transmit antenna(s) into the target, as described herein. The first response signals are used by the sensor system to detect the first analyte in the target (e.g., detect the presence of the first analyte in the target, detect the amount of first analyte in the target at 1080).

At 1050, the sensor transmits the second transmit signals at a second plurality of transmit frequencies of the second detection frequency sweep. The second transmit signals are in a radio or microwave range of the electromagnetic spectrum. The second transmit signals are transmitted using at least a second transmit antenna of the plurality of antennas of the sensor (e.g., one or more transmit antennas 11 in the antenna array 14). The transmitted second plurality of transmit frequencies have the (second) detection parameters so as to implement the second transmit frequency sweep. For example, the second plurality of transmit frequencies are at the (second) power level, in the (second) frequency range, and/or at the (second) frequency step size. For example, the second plurality of transmit frequencies can include a transmit signal with the maximum frequency of the second frequency range, a transmit signal with the minimum frequency of the second frequency range, and one or more transmit signals at each frequency step between the maximum frequency and the minimum frequency.

In an embodiment, the first transmit antenna(s) used for transmitting the first transmit signals at 1030 and the second transmit antenna(s) used for transmitting the second transmit signals at 1050 may be the same antenna(s) of the sensor. In another embodiment, the first transmit antenna(s) and the second transmit antenna(s) may be different antennas of the sensor (e.g., different antennas in the antenna array 14).

At 1060, the sensor detects (second) response signals at the second plurality of transmit frequencies. The second response signals are detected using a second receive antenna of the plurality of the antennas of the sensor (e.g., receive antenna 13). In an embodiment, the first receive antenna used for detecting the first response signals at 1040 and the second receive antenna used for detecting the second response signals at 1060 may be the same antenna. In another embodiment, the first receive antenna and the second receive antenna may be different antennas of the sensor (e.g., different antennas in the antenna array 14). The (second) response signals result from the transmission of the (second) transmit signals by the second transmit antenna into the target, as described herein. The second response signals can then be used by the sensor system to detect the second analyte in the target (e.g., detect the presence of the second analyte in the target, detect the amount of the second analyte in the target at 1090).

At least one of the first detection parameters of the first detection frequency sweep are different from at least one of the second detection parameters of the second detection frequency sweep (i.e., the first detection sweep is different from the second detection sweep). For example, one or more of the frequency range, the power level, and the frequency step size of the first detection frequency sweep is different from the corresponding one of the frequency range, the power level, and/or the frequency step size of the second detection frequency sweep (e.g., first frequency range is different from the second frequency range, the first power level is different from the second power level, and/or the first frequency step size is different from the second frequency size). The (first) detection parameters are specific to detecting/interacting with the first analyte in the target and the (second) detection parameters are specific to detecting/interacting with the second analyte in the target.

Partial examples of the first detection sweep and the second detection sweep that can be implemented are shown below in Table 1 and Table 2. In this example, the first detection sweep has a frequency range of 1600-2100 Mhz, a frequency step size of 20 Mhz, and a power level that includes amplitude A₁, amplitude A₂, and amplitude A₃. The first detection sweep also includes operation times of 20 μs, 30 μs, and 40 μs for transmitting at each step/frequency. For example, step 3 in the first frequency sweep is a transmit signal having a frequency of 1640 Mhz, an amplitude of A₁, and a duration of 20 μs. In addition, this example shows the second detection sweep as having a frequency range of 1300-1700 MHz, a frequency step size of 40 Mhz, and a power level that includes transmitting at amplitude A₁, amplitude A₃, amplitude A₄, and amplitude A₅. The second detection sweep also includes operation times of 20 μs, 25 μs, and 30 μs for transmitting at each step/frequency. In the examples illustrated in Tables 1 and 2, some of the detection parameters for the first frequency sweep are different from some of the corresponding detection parameters for the second frequency sweep. For example, the target frequency and target amplitudes are different between the first frequency sweep and the second frequency sweep. One or more of the detection parameters in the first frequency sweep and the second frequency sweep may be the same. For example, the operation times used in the first frequency sweep and in the second frequency sweep may be the same. In another embodiment, the target amplitudes of the first frequency sweep and the power level of the second frequency sweep may be the same (i.e., the amplitudes for the first transmit signals and amplitudes for the second transmit signals can be the same). Although Table 1 and Table 2 show the same respective step size in each sweep, within each frequency sweep the step size may vary.

Within a single frequency sweep (for example, the first frequency sweep of Table 1 or the second frequency sweep of Table 2), the detection parameters may be the same. For example, the operation times and the target amplitudes may be the same at each step.

TABLE 1
First Detection Frequency Sweep

| | Target Frequency | Operation Time | |
|---|---|---|---|
| Step | (MHz) | (μs) | Target Amplitude* |
| 1 | 1600 | 20 | A₁ |
| 2 | 1620 | 20 | A₁ |
| 3 | 1640 | 30 | A₂ |
| 4 | 1660 | 30 | A₃ |
| 5 | 1680 | 40 | A₃ |
| . . . | . . . | . . . | . . . |
| N | 2100 | 20 | A₂ |

*A₁, A₂, and A₃ are different amplitudes from each other.

TABLE 2
Second Detection Frequency Sweep

| | Target Frequency | Operation Time | |
|---|---|---|---|
| Step | (MHz) | (μs) | Target Amplitude* |
| 1 | 1200 | 20 | A₁ |
| 2 | 1240 | 20 | A₁ |
| 3 | 1280 | 30 | A₄ |
| 4 | 1320 | 30 | A₄ |
| 5 | 1360 | 40 | A₅ |
| . . . | . . . | . . . | . . . |
| n | 1700 | 20 | A₃ |

*A₁, A₃, A₄, and A₅ are different amplitudes from each other.

At 1080, the sensor system determines an amount of the first analyte in the target based on the detected first response signals. For example, the sensor (controller 17 of the sensor 5), an external device of the sensor system (e.g., external device 25), and/or a remote server in communication with the sensor (e.g., remote server 27) may determine the amount of the first analyte in the target based on the first response signals. In an embodiment, the sensor and/or the external device of the sensor system may be configured to determine the amount of the first analyte in the target based on the first response signals. The detected amount of the first analyte may be displayed on a screen (not shown) of the sensor or the external device.

At 1090, the sensor system determines an amount of the second analyte in the target based on the detected second response signals. For example, the sensor (controller 17 of the sensor 5), an external device of the sensor system (e.g., external device 25), and/or a remote server in communication with the sensor (e.g., remote server 27) may determine the amount of the second analyte in the target based on the second response signals. In an embodiment, the sensor and/or the external device of the sensor system may be configured to determine the amount of the second analyte in the target based on the second response signals. The detected amount of the second analyte may be displayed on a screen (not shown) of the sensor or the external device.

The method 1000 may also include the sensor implementing a third detection frequency sweep at 1070. Implementing the third detection frequency sweep 1070 can include determining the third detection frequency sweep at 1072, transmitting third transmit signals at a third plurality of transmit frequencies of the third detection frequency sweep into the target at 1074, and detecting third response signals at 1076. The third transmit signals are in a radio or microwave range of the electromagnetic spectrum. The (third) response signals result from the transmission of the (third) transmit signals by the third transmit antenna into the target, as described herein. The third transmit signals can be transmitted using a third transmit antenna of the plurality of antennas of the sensor (e.g., a transmit antenna 11 of the antenna array 14), and the third response signals can be detected using a third receive antenna of the plurality of antennas of the sensor (e.g. a receive antenna 13 of the antenna array 14). The third transmit antenna may be the same antenna or a different antenna from the first transmit signal and/or the second transmit antenna used for transmitting the first transmit signals and the second transmit signals, respectively. The third receive antenna may be the same antenna or a different antenna from the first receive antenna and/or the second receive antenna used for the detecting the first response signals and the second response signals, respectively.

In an embodiment, the third detection frequency sweep at 1070 may be for detecting a third analyte. In such an embodiment, third detection frequency sweep can include (third) detection parameters for detecting the third analyte as similarly described herein for the first detection sweep and the second detection frequency sweep, except the third parameters being for detecting the third analyte. The (third) detection parameters are specific to detecting the third analyte in the target. At least one of the (third) detection parameters of the third detection frequency sweep being different from (first) detection parameters of the first detection frequency sweep and the (second) detection parameters of the second detection frequency sweep. For example, one or more of the frequency range, the power level, and the frequency step size of the third detection frequency sweep being different from the corresponding one of the frequency range, the power level, and/or the frequency step size of the first detection frequency sweep and of the second detection frequency sweep. The detected third response signals detected at 1076 can then be used by the sensor system to detect the third analyte in the target (e.g., detect the presence of the third analyte in the target, detect the amount of the second analyte in the target at 1090).

In an embodiment, the third detection frequency sweep may be for detecting the first analyte. In one example, the third detection frequency sweep may be a repeat of the first detection frequency sweep and used for more accurately detecting/measuring the first analyte in the target. In such an example, the determining of third frequency sweep 1072 can select the same detection parameters for the third frequency sweep as used/determined for the first frequency sweep at 1020 (i.e., selecting the first detection parameters as the (third) detection parameters for the third frequency sweep). In another example, the third detection frequency sweep may be a different frequency sweep from the first detection frequency sweep that is used along with results of the first detection sweep to detect the first analyte. The (first) response signals and the (third) response signals being used to detect the third analyte in the target. In such an example, the determining of the amount of the first analyte at 1080 can be determining the amount of the first analyte in the target based on the first response signals and the third response signals.

In FIG. 3, the determining of the second detection frequency sweep 1020 occurs before transmitting the first transmit signals 1030. In another embodiment, the determining of the second frequency sweep 1020 may occur after transmitting the first transmit signals 1030. In FIG. 3, the first transmit signals are transmitted 1030 before the second transmit signals are transmitted 1050. In another embodiment, the transmitting of the second transmit signals 1050 may occur before the transmitting of the first transmit signals 1030. In FIG. 3, the implementing of the third detection frequency sweep 1070 is after the detecting of the first response signals 1040 and the detection of the second response signals 1060. In another embodiment, 1072, 1074, and/or 1076 in implementing the third frequency step 1070 may occur before the transmitting of the first transmit signals 1030 and/or before the transmitting of the second transmit signals 1050.

The examples disclosed in this application are to be considered in all respects as illustrative and not limitative. The scope of the invention is indicated by the appended claims rather than by the foregoing description; and all changes which come within the meaning and range of equivalency of the claims are intended to be embraced therein.

1. A method of operating a sensor system to detect a first analyte and a second analyte in a target, the first analyte being a different analyte from the second analyte, the sensor system including a non-invasive sensor having a plurality of antennas, the method comprising:
determining a first detection frequency sweep based on the first analyte to be detected, the first detection frequency sweep including first detection parameters;
determining a second detection frequency sweep based on the second analyte to be detected, the second detection frequency sweep including second detection parameters, at least one of the first detection parameters in the first detection frequency sweep being different from a corresponding one of the second detection parameters in the second detection frequency sweep;
transmitting, using at least a first transmit antenna of the plurality of antennas, first transmit signals at a first plurality of transmit frequencies of the first detection frequency sweep, the first transmit signals being in a radio or microwave range of the electromagnetic spectrum;
detecting, using at least a first receive antenna of the plurality of antennas, first response signals resulting from the transmission of the first transmit signals by at least the first transmit antenna into the target;
transmitting, using at least a second transmit antenna of the plurality of antennas, second transmit signals at a second plurality of transmit frequencies of the second detection frequency sweep, the second transmit signals being in a radio or microwave range of the electromagnetic spectrum; and
detecting, using at least a second receive antenna of the plurality of antennas, second response signals resulting from the transmission of the second transmit signals by at least the second transmit antenna into the target.

2. The method of claim 1, wherein:
the first detection parameters include a first frequency range, a first power level, and a first step size, and
the second detection parameters include a second frequency range, a second power level, and a second step size.

3. The method of claim 2, wherein at least one of:
the first frequency range is different from the second frequency range,
the first power level is different from the second power level, and
the first step size is different from the second step size.

4. The method of claim 2, wherein:
the first frequency range is different from the second frequency range,
the first power level is different from the second power level, and
the first step size is different from the second step size.

5. The method of claim 1, wherein:
the first transmit antenna and the second transmit antenna are the same, or
the first transmit antenna and the second transmit antenna are different antennas.

6. The method of claim 1, wherein:
the first receive antenna and the second receive antenna are the same, or
the first receive antenna and the second receive antenna are different antennas.

7. The method of claim 1, wherein the determining of the second detection frequency sweep occurs after the transmitting of the first transmit signals.

8. The method of claim 1, wherein the determining of the second detection frequency sweep occurs before the transmitting of the first transmit signals.

9. The method of claim 1, further comprising:
determining an amount of the first analyte based on the first response signals; and
determining an amount of the second analyte based on the second response signals.

10. The method of claim 1, wherein the first analyte is glucose.

11. The method of claim 1, wherein the first analyte is glucose, and the second analyte is one of: a drug or pharmaceutical composition, or a chemical generated within the body.

12. The method of claim 1, wherein the sensor system is a non-invasive sensor system, and the method operates the non-invasive sensor system to non-invasively detect the first analyte and a second analyte in the target.

13. The method of claim 1, further comprising:
determining a third detection frequency sweep based on the first analyte to be detected, the third detection frequency sweep including third detection parameters;
transmitting, using at least a third transmit antenna of the plurality of antennas, third transmit signals at a third plurality of transmit frequencies of the third detection frequency sweep, the third transmit signals being in a radio or microwave range of the electromagnetic spectrum; and
detecting, using at least a third receive antenna of the plurality of antennas, third response signals resulting from the transmission of the third transmit signals by the third transmit antenna into the target.

14. The method of claim 1, further comprising:
determining a third detection frequency sweep based on a third analyte to be detected, the third detection frequency sweep including third detection parameters, at least one of the third detection parameters in the third detection frequency sweep being different from a corresponding one of the first detection parameters in the first detection frequency sweep, and at least one of the third detection parameters in the third detection frequency sweep being different from a corresponding one of the second detection parameters in the second detection frequency sweep;
transmitting, using at least a third transmit antenna of the plurality of antennas, third transmit signals at a third plurality of transmit frequencies of the third detection frequency sweep, the third transmit signals being in a radio or microwave range of the electromagnetic spectrum; and
detecting, using at least a third receive antenna of the plurality of antennas, third response signals resulting from the transmission of the third transmit signals by the third transmit antenna into the target.

15. A sensor system comprising:
a non-invasive sensor for non-invasively detecting a first analyte and a second analyte in a target, the first analyte being a different analyte from the second analyte, the non-invasive sensor including a plurality of antennas, the plurality of antennas positioned and arranged to transmit into the target and to detect a response resulting from the transmitting into the target;
a controller including a non-transitory memory, first detection parameters for detecting the first analyte and second detection parameters for detecting the second analyte being stored in the non-transitory memory,
wherein the controller is configured to control the non-invasive sensor to detect the first analyte and the second analyte in the target, wherein the controller:
determines a first frequency sweep having the first detection parameters stored in the non-transitory memory for detecting the first analyte,
determines a second frequency sweep having the second detection parameters stored in the non-transitory memory for detecting the second analyte, and at least one of the first detection parameters in the first detection frequency sweep being different from a corresponding one of the second detection parameters in the second detection frequency sweep,
controls the non-invasive sensor to transmit, using at least a first transmit antenna of the plurality of antenna, first transmit signals at a first plurality of transmit frequencies of the first detection frequency sweep, the first transmit signals being in a radio or microwave range of the electromagnetic spectrum,
controls the non-invasive sensor to receive, using at least a first receive antenna of the plurality of antennas, first response signals resulting from the transmission of the first transmit signals by at least the first transmit antenna into the target,
controls the non-invasive sensor to transmit, using at least a second transmit antenna of the plurality of antennas, second transmit signals at a second plurality of transmit frequencies of the second detection frequency sweep, the second transmit signals being in a radio or microwave range of the electromagnetic spectrum, and
controls the non-invasive sensor to receive, using at least a second receive antenna of the plurality of antennas, second response signals resulting from the transmission of the second transmit signals by at least the second transmit antenna into the target.

16. The sensor system of claim 15, wherein:
the first detection parameters include a first frequency range, a first power level, and a first step size, and
the second detection parameters include a second frequency range, a second power level, and a second step size.

17. The sensor system of claim 16, wherein at least one of:
the first frequency range is different from the second frequency range,
the first power level is different from the second power level, and
the first step size is different from the second step size.

18. The sensor system of claim 16, wherein:
the first frequency range is different from the second frequency range,
the first power level is different from the second power level, and
the first step size is different from the second step size.

19. The sensor system of claim 15, wherein:
the first transmit antenna and the second transmit antenna are the same, or
the first transmit antenna and the second transmit antenna are different antennas.

20. The sensor system of claim 15, wherein the first analyte is glucose.

21. The sensor system of claim 15, wherein the first analyte is glucose, and the second analyte is one of: a drug or pharmaceutical composition, or a chemical generated within the body.

22. The sensor system of claim 15, wherein the sensor system is a non-invasive sensor system configured to non-invasively detect the first analyte and the second analyte in the target.

23. A non-invasive sensor for detecting a first analyte and a second analyte in a target, the first analyte being a different analyte from the second analyte, comprising:
a plurality of antennas positioned and arranged to transmit into the target and to detect a response resulting from the transmitting into the target;
a controller including a non-transitory memory, first detection parameters for detecting the first analyte and second detection parameters for detecting the second analyte being stored in the non-transitory memory,
wherein the controller is configured to control the non-invasive sensor to detect the first analyte and the second analyte in the target, wherein the controller:
determines a first frequency sweep having the first detection parameters stored in the non-transitory memory for detecting the first analyte,
determines a second frequency sweep having the second detection parameters stored in the non-transitory memory for detecting the second analyte, and at least one of the first detection parameters in the first detection frequency sweep being different from a corresponding one of the second detection parameters in the second detection frequency sweep,
controls the non-invasive sensor to transmit, using at least a first transmit antenna of the plurality of antenna, first transmit signals at a first plurality of transmit frequencies of the first detection frequency sweep, the first transmit signals being in a radio or microwave range of the electromagnetic spectrum,
controls the non-invasive sensor to receive, using at least a first receive antenna of the plurality of antennas, first response signals resulting from the transmission of the first transmit signals by at least the first transmit antenna into the target,
controls the non-invasive sensor to transmit, using at least a second transmit antenna of the plurality of antennas, second transmit signals at a second plurality of transmit frequencies of the second detection frequency sweep, the second transmit signals being in a radio or microwave range of the electromagnetic spectrum, and
controls the non-invasive sensor to receive, using at least a second receive antenna of the plurality of antennas, second response signals resulting from the transmission of the second transmit signals by at least the second transmit antenna into the target.

24. The non-invasive sensor of claim 23, wherein:
the first detection parameters include a first frequency range, a first power level, and a first step size, and
the second detection parameters include a second frequency range, a second power level, and a second step size.

25. The non-invasive sensor of claim 24, wherein at least one of:
the first frequency range is different from the second frequency range,
the first power level is different from the second power level, and
the first step size is different from the second step size.

26. The non-invasive sensor of claim 24, wherein:
the first frequency range is different from the second frequency range,
the first power level is different from the second power level, and
the first step size is different from the second step size.

27. The non-invasive sensor of claim 23, wherein:
the first transmit antenna and the second transmit antenna are the same, or
the first transmit antenna and the second transmit antenna are different antennas.

28. The non-invasive sensor of claim 23, wherein the first analyte is glucose.

29. The non-invasive sensor of claim 23, wherein the first analyte is glucose, and the second analyte is one of: a drug or pharmaceutical composition, or a chemical generated within the body.
